(19) United States
(12) Patent Application Publication
(10) Pub. No.: US 2025/0198536 A1
(43) Pub. Date: Jun. 19, 2025

(54) DEVICE FOR EXTERNAL ACTUATION OF VALVES WITH A DAMAGED BUSHING

(71) Applicant: Petróleo Brasileiro S.A. - Petrobras, Rio de Janeiro (BR)

(72) Inventors: THIAGO RAFAEL DE OLIVEIRA, Betim (BR); WAGNER HENRIQUE SALDANHA, Betim (BR); VINICIUS SANTOS LIMA, Betim (BR); ELBERT FERNANDO MARTINS COELHO, Betim (BR)

(73) Assignee: Petróleo Brasileiro S.A. - Petrobras, Rio de Janeiro, RJ (BR)

(21) Appl. No.: 18/979,413

(22) Filed: Dec. 12, 2024

(30) Foreign Application Priority Data
Dec. 13, 2023 (BR) 2020230262339

(51) Int. Cl. F16K 31/44

(52) U.S. Cl. CPC F16K 31/44

(57) ABSTRACT

The present utility model basically refers to a device that comprises a set of stabilizer plates connected by means of tie rods responsible for adjusting to different types and sizes of valves, so that, when coupled to said stabilizer plate by means of a threaded connection there is a drive rod responsible for opening and closing the valve. Connection between the valve's main rod and the device's drive rod is made by means of a set of freely rotating bushings, driving the clamp to start and the valve to open. The actuator's action and reaction frame is fixed to the valve body itself by means of adjustable joints and/or tie rods which allows the device to be adjusted to various valve diameters.

### FIELD OF THE UTILITY MODEL

The present model is within the field of pipeline repair, specifically in the repair of coatings of pipeline components for oil exploration and transportation, more specifically in the repair of pipelines using external mechanical devices.

### BACKGROUND OF THE MODEL

Routinely, events of breakage and/or wear of gate and globe valve bushings occur in process units. This can happen due to adverse operating conditions, natural wear and tear over time, or unexpected events. These failures render these valves inoperative, causing difficulty in operational maneuvers, or, in some instances, rendering such maneuvers impossible.

Typically, when such valves became inoperative, the operational maneuver was impossible to be carried out until a new bushing was manufactured and assembled, leading to the completion of corrective maintenance of the valve. However, these corrective maintenance services often require a long time to be carried out, causing impacts on the process and system reliability.

Over time, more specialized technologies for valve repair have emerged. It included the development of external mechanical devices designed to specifically address defects in bushings.

In cases of less severe damage, temporary sealing techniques have been developed. This could involve using special sealants or external fastening devices to temporarily block leaks. Over time, various technologies have emerged for repairing pipes and valves. Technologies have been developed to temporarily seal leaks, such as the use of external mechanical devices that can be attached to pipes, blocking the passage of fluids.

Therefore, the repair of oil pipelines and their valves using external mechanical devices is a critical area of the oil and gas industry, which demands efficient solutions to ensure operational safety and production continuity.

The proposed solution is based on the manufacture of a device that allows valves to be actuated (opened and closed), even with the original bushing damaged. The proposed solution is intended to allow the valves to be actuated in the given condition, allowing operational maneuvers to be carried out, and giving the maintenance crew more time to carry out adequate planning for a definitive intervention.

### STATE OF THE ART

The search for the history of the present model resulted in the finding of some relevant state-of-the-art documents, which still present unsolved technical differences and defects.

CN110939822 relates to a maintenance and emergency repair device for a lining repair pipe, which comprises a plug, a PU rubber piece, a liner, an elastic conical block, a hoop, a nut, a screw, a steel sheet and a steel pipe clamp The lower end of the plug is connected with the steel sheet, the steel sheet is provided with the PU rubber piece, and the PU rubber piece and the steel sheet are arranged in the steel pipe; the bushing wraps outside the plug, the upper half portion of the bushing is arranged above the steel pipe, the periphery of the lower half portion of the bushing is wrapped with the elastic conical block, and the elastic conical block is arranged in an upper plane of the PU rubber piece; the nut is fixed on the upper part of the plug, the elastic conical block is enabled to reversely press a leakage point upwards by screwing the nut on the upper part, the leakage point can be quickly plugged, the construction cost is reduced, the construction period is shortened, and the construction efficiency is improved.

It can immediately be seen that they are totally different applications. The new utility model aims to open valves whose bushing actuation mechanism has failed, while the art of CN110939822 refers to a maintenance and emergency repair device for a lining repair pipe. It is even stated that: “The elastic conical block is enabled to press a leakage point upwards by screwing the nut on the upper part, the leakage point can be quickly plugged, the construction cost is reduced, the construction period is shortened, and the construction efficiency is improved.” The proposed model is not specifically related to the resolution of leakages, but rather to temporary repairs to promote the opening and closing of valves with damaged bushings, so they are different applications.

U.S. Pat. No. 4,128,930 shows a technical problem relative to the fact that it is often desired to temporarily block a pipe against the flow of fluids while a plumbing element, such as a valve, is attached to the end of the pipe or while a defective plumbing element, such as a leaking valve, is removed from the end of the pipe and replaced with a new one.

U.S. Pat. No. 4,128,930 discloses a plumbing device including a radially outwardly and resiliently expansible sealing plug carried on the front end of an elongated axial shaft. An elongated cylinder disposed about the shaft transmits axial movement to the plug from a jack mechanism near the rear end of the shaft so as to cause the expansion of the plug into sealing engagement with the inner surface of a pipe in which it is positioned. An external shackle is clamped about the pipe and carries a pair of elongated threaded rods which extend rearwardly beyond the jack mechanism so that a rear lock gate plate can be placed over the axial shaft and secured on each of the threaded rods so as to abut the jack mechanism and so prevent rearward axial displacement of the plug within the pipe under the action of fluid pressure therein.

Also in U.S. Pat. No. 4,128,930, an externally threaded sleeve is freely disposed about the elongated cylinder so that an internally threaded split bushing can be placed about that sleeve and engaged by a front lock gate plate which can also be secured on the threaded rods extending from the pipe-clamping shackle. By alternating the clamping function between the front and rear lock gate plates, it is possible to move a pipe fitting along the device and consequently to remove such a fitting from the end of the pipe and/or to secure a new or replacement fitting on that pipe end.

It should be noted that U.S. Pat. No. 4,128,930 further focuses on repairing leaks in pipes, while the present model was developed to operate the opening and closing of valves with no bushing, or with a defective bushing, something that could not be performed with the aforementioned device.

CN218913755 relates to a utility model for a valve copper bush failure repairing device, which is installed above a valve body and comprises a supporting frame and a threaded rod, wherein the supporting frame is fixedly connected above the valve body, the threaded rod is in threaded connection with the supporting frame, and the tail portion of the threaded rod is fixedly connected with an original valve rod; the threaded rod is driven to rotate on the supporting frame so as to drive the original valve rod to move up and down in the valve body.

In the model disclosed in CN218913755, the valve copper bush failure repairing device can drive the threaded rod by rotating the hand wheel, and under the action of the supporting frame, the threaded rod can drive the original valve rod connected with the threaded rod to move up and down in the valve body, so as to drive the valve to move.

However, it should be noted that, according to claims 4 and 5 of CN218913755, it can be noted that said device is fixedly connected either to the original rod or to the body of the damaged valve, by means of a welded connection. In contrast, the present model consists of a system of external bushings using freely rotating threaded connections coupled to the end of the rod, being actuated by a new tie rod, without the need for any welding operation. The actuator's action and reaction frame is fixed to the valve body itself by means of adjustable joints and/or tie rods, which allows the device to be adjusted to various valve diameters.

It should be noted that the original valve rods are mostly manufactured from noble materials such as 300 and 400 series stainless steel, which requires a more complex welding procedure and, therefore, an unexpected failure of a bushing will require all requirements of this procedure to be met. Furthermore, in several oil and gas facilities there are piping systems that are not close to electrical installations, which would make the application of the device disclosed in CN218913755 unfeasible.

Moreover, it is important to consider the fact that valves routinely have small hydrocarbon leaks through the gaskets, leaving the atmosphere around the valve explosive, which makes it impossible to perform a welding process on its body and rod and, accordingly, the device of CN218913755 cannot be used.

Furthermore, the actuator's action and reaction frame is fixed to the valve body itself by means of adjustable joints and/or tie rods which allows the device of the present model to be adjusted to various valve diameters.

The use of stabilizing plates and adjustable tie rods makes the new model significantly different from the device of CN218913755, as it fits into the universal device category, and can be easily disassembled and used several times in different locations, while the CN218913755 refers to a welded part with a single application.

Finally, it should be noted that the present utility model is a device that will provide greater safety, reliability and efficiency to installations, providing quick and autonomous interventions without the need for specialized labor in welding and boiler making. In addition to being a tool that contributes to the concept of autonomous maintenance, as the operator himself can easily install and remove it.

In summary, the new form or arrangement of reinforcement elements is evident in the fact that none of the listed documents discloses an arrangement of freely rotating external bushings coupled to the end of the rod, being actuated by a tie rod, so that the action and reaction frame of the actuation is fixed to the valve body itself by means of adjustable joints and/or tie rods.

Furthermore, said new form leads to an improvement in the use of said device because, in addition to avoiding the need for a welding process under extreme operating conditions, it allows the device to be adjusted for various valve diameters due to the use of the arrangement of joints and/or adjustable tie rods.

### BRIEF DESCRIPTION OF THE UTILITY MODEL

To manufacture this device, the dimensions of the valve rods installed in the process unit were initially mapped. The present utility model basically refers to a device that comprises a set of stabilizer plates connected by means of tie rods responsible for adjusting to different types and sizes of valves, so that, when coupled to said stabilizer plate by means of a threaded connection there is a drive rod responsible for opening and closing the valve. Connection between the valve's main rod and the device's drive rod is made by means of a set of freely rotating bushings, driving the clamp to start and the valve to open. The actuator's action and reaction frame is fixed to the valve body itself by means of adjustable joints and/or tie rods which allows the device to be adjusted to various valve diameters.

### BRIEF DESCRIPTION OF THE FIGURES

FIG. 1 shows the entire assembly of said device, comprising: a connecting element (1) between the rod and the bushing, a connecting bushing (2), a drive bushing (3), a counter nut (4), an upper stabilizing plate (5), a driving rod (6), a fastening rod (7), a regulating lock (8), a lower stabilizing plate (9) and fastening nuts (10).

FIG. 2 shows a detailed description of the regulating lock to be adapted to different valve diameters.

FIG. 3 shows a top view of the upper stabilizer plate (5).

FIG. 4 shows a detailed view of the first component of the drive bushing (3).

FIG. 5 shows a detailed view of the second component of the drive bushing (3).

FIG. 6 shows a detailed view of the third component of the drive bushing (3).

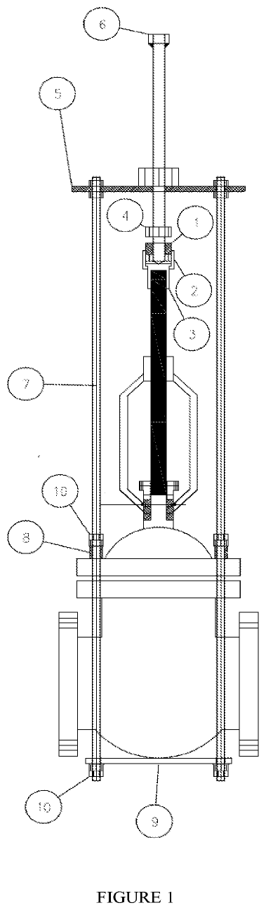

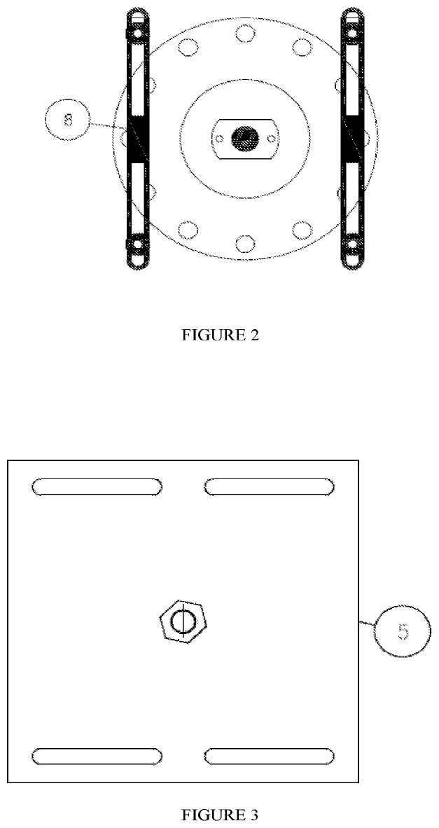

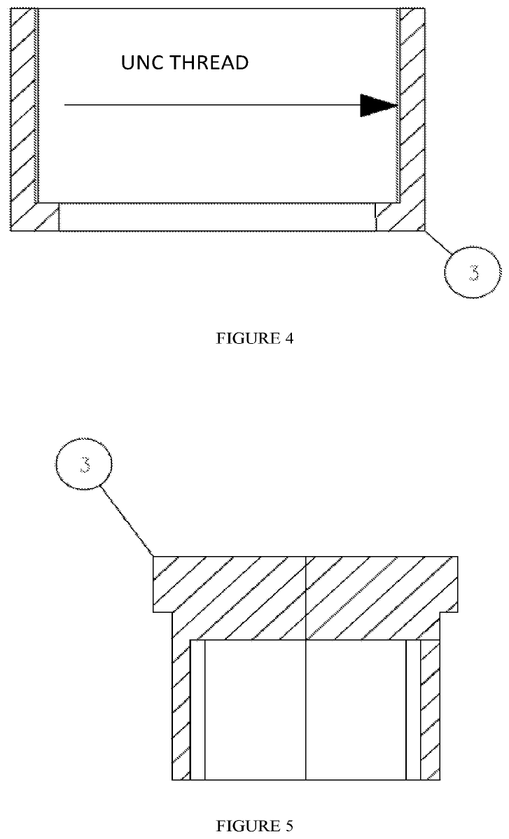

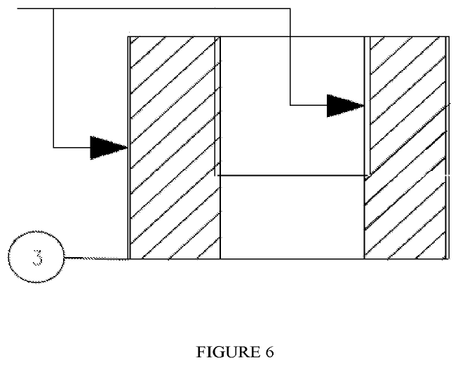

### DETAILED DESCRIPTION OF THE UTILITY MODEL

The present utility model refers to a device basically composed of a set of stabilizing plates connected by means of tie rods or alternatively an articulated anchoring clamp, these parts being responsible for being adjusted to different types and sizes of valves. Coupled to said stabilizing plate by means of a threaded connection is an actuating rod responsible for opening and closing the valve. Connection between the valve's main rod and the device's drive rod is made by means of a set of freely rotating bushings, driving the clamp to start and the valve to open.

In summary, the present model comprises the following components: a connecting element (1) between the rod and bushings, a connecting bushing (2), drive bushing (3), counter nut (4), upper stabilizing plate (5), driving rod (6), fastening rods (7), a regulating lock (8), a lower stabilizing plate (9) and a fastening nut-screw assembly (10).

The device for external actuation of valves with damaged bushing comprises at least two opposing stabilizing plates, the lower stabilizing plate (9) fastened to the upper stabilizing plate through holes arranged at its vertices, comprising fastening tie rods (7) connected by reversible fastening elements (10), each pair of tie rods comprising in a median portion thereof a regulating lock (8).

The device further comprises a drive rod (6) fastened in the center of the upper stabilizing plate (5) by means of a reversible fastening element, and, in a lower portion it receives a connecting element (1) between said rod and the connecting bushing, and the connecting bushing (2) connects to the drive bushing (3) with the aid of a counter nut (4) located just above the connecting element (1), so that the drive bushing (3) connects to the main valve rod with freedom of rotation around its own axis.

The reversible fastening element (10) is preferably a nut-screw assembly.

The device manufactured with the model shown was manufactured and tested to operate valves with damaged bushings (test carried out on a 1.½″ 800″ gate valve and a 6″ 300 #gate valve), having presented satisfactory results.

In said test, the valves could be operated even with damaged bushings, and allowed the planned operational maneuver to be carried out. Field test: When performing an operational maneuver to close the blocking valve of the low pressure steam manifold, the bushing broke, the device was installed to enable rationing of the damaged valve in the low pressure steam system of 3.5 kgf/cm², with satisfactory results both in opening and in the tightness of the closing.

Those skilled in the art will value the knowledge presented herein and may reproduce the model in the disclosed embodiments and other variants thereof, as covered by the scope of the appended claims.

1. A DEVICE FOR EXTERNAL ACTUATION OF VALVES WITH DAMAGED BUSHING characterized in that it comprises at least two opposing stabilizer plates, the lower stabilizer plate (9) fastened to the upper stabilizer plate through holes arranged at its vertices, comprising fixing tie rods (7) connected by reversible fastening elements (10), each pair of tie rods comprising in a median portion an adjusting lock (8) and also a drive rod (6) fastened in the center of the upper stabilizer plate (5) by means of a reversible fastening element, wherein the lower portion of said rod (6) receives a connecting element (1) between said rod (1) and the connecting bushing (2), and the connecting bushing (2) connects to the drive bushing (3), which connects to the main rod of the valve, with the aid of a counter nut (4) located just above the connecting element (1).
